(19) United States
(12) Patent Application Publication
(10) Pub. No.: US 2006/0233558 A1
(43) Pub. Date: Oct. 19, 2006

(54) Jam removing device and image forming apparatus including the same, and jam removing method

(75) Inventor: Jung-woo Son, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/404,872

(22) Filed: Apr. 17, 2006

(30) Foreign Application Priority Data
Apr. 15, 2005 (KR) 2005-31411

(51) Int. Cl. G03G 15/00

(52) U.S. Cl. 399/18; 399/21

(57) ABSTRACT

A jam removing device in an image forming apparatus includes: jam detecting units mounted on the feed path and the discharge path to detect jams; a drive controlling unit to drive a driving source by opening a cover unit; and a pickup determining unit determines performing of a pickup operation by a pickup roller according to the location of the paper. The jam removing method includes: detecting the jam by the jam detecting unit; driving the driving source for a predetermined amount of time where the jam is detected; determining to perform the pickup operation by the pickup roller according to the location of the paper; and discharging the paper using the discharging unit. Since a conveying device is typically not mounted on the feed path, the manufacturing cost can be reduced. Accordingly, user inconvenience and service due to jams can be reduced, thereby increasing the reliability of the product.

### CROSS-REFERENCE TO RELATED PATENT APPLICATION

This application claims the benefit of Korean Application No. 2005-31411, filed Apr. 15, 2005 in the Korean Intellectual Property Office, the disclosure of which is incorporated herein in its entirety by reference.

### BACKGROUND OF THE INVENTION

1. Field of the Invention

Aspects of the invention relate to an image forming apparatus, and, more particularly, aspects of the invention relate to a jam removing device and an image forming apparatus including a jam removing device, and a jam removing method, which can efficiently remove a jam which occurs where conveying paper.

2. Description of the Related Art

Generally, an image forming apparatus such as a laser printer, an LED printer, a digital copier, a facsimile, or an inkjet printer forms an image on paper which is conveyed along a path; and the image forming apparatus determines whether a jam of the paper occurs using a plurality of sensors on the conveying path of the image forming apparatus.

FIG. 1 shows a conventional process of removing a jam in an image forming apparatus. Referring to FIG. 1, after a printing operation starts (operation 10), the plurality of the sensors on the conveying path of the image forming apparatus detect whether the jam of the paper occurs (operation 20). Where the jam occurs, the sensor which detects the jam generates a jam signal. Then, in order to remove the jam, a user opens a cover unit (operation 30) and drives a driving source (operation 40), which operates conveying rollers to discharge the jammed paper from the image forming apparatus. Then, a reprinting operation is performed (operation 60).

In the image forming apparatus operated by the conventional process of FIG. 1, the jammed paper can be removed by opening the cover unit where the jam occurs. However, since a conveying device is typically not mounted between a pickup roller and an image forming unit (that is, on a feed path) where the jam occurs on the feed path, the jammed paper can not be removed by the above process. Since the conveying device is not mounted on the feed path, the jammed paper can not be conveyed even where the driving source is driven. Where the jam occurs on the feed path, one side of the jammed paper generally contacts a pickup roller. Accordingly, in this case, by operating the pickup roller, the jammed paper can be conveyed along the feed path.

However, where the jam is generated on a discharge path, the jammed paper can not be removed by this process. Where the pickup roller is operated where the jam occurs on the discharge path, a new sheet of paper is picked up and a double pickup typically occurs. That is, two sheets of paper are located on the discharge path.

Therefore, it must be determined whether the pickup operation will be performed by the pickup roller according to the location of the jammed paper. Further, the jammed paper typically can not be easily removed where the jam occurs on the feed path which has no conveying device.

### SUMMARY OF THE INVENTION

Several aspects and embodiments of the invention provide a jam removing device and an image forming apparatus including a jam removing device, and a jam removing method, which can efficiently remove jammed paper, even though a conveying device is not mounted on a feed path, and can enhance reliability.

According to an aspect of the present invention, there is provided a jam removing method of an image forming apparatus including a cover unit to selectively open and close, an image forming unit to form an image on a sheet of paper conveyed along a feed path by a pickup roller, a discharging unit to discharge the paper from the image forming apparatus along a discharge path, a driving source to drive the discharging unit, and a jam detecting unit, mounted on a conveying path of the paper, to detect a jam, the jam removing method including: detecting a jam of the paper in the image forming apparatus by the jam detecting unit; driving the driving source for a predetermined amount of time where a jam of the paper occurs in the image forming apparatus; determining to selectively perform a pickup operation by the pickup roller according to the location of the paper, where a jam occurs in the image forming apparatus; and discharging the paper from the image forming apparatus by the discharging unit.

According to aspects of the invention, the detecting of the jam can include detecting the jam using the jam detecting unit, the jam detecting unit including: a feed sensing unit, mounted on the feed path, to detect jams on the feed path; and a discharge sensing unit, mounted on the discharge path, to detect jams on the discharge path.

The driving of the driving source, according to aspects of the invention, can further include driving the driving source in response to a jam releasing signal generated by opening the cover unit. The generating of the jam releasing signal can include: detecting the cover unit being opened using an opening detecting unit; and generating the jam releasing signal by a signal generating unit where the cover unit is opened.

The determining of the pickup operation being performed, according to aspects of the invention, can further include detecting the location of the paper using the jam detecting unit in response to driving the driving source. Also, the jam detecting method, according to aspects of the invention, can further include: controlling the pickup roller to operate where the paper is located on the feed path; and controlling the pickup roller to not operate where the paper is located on the discharge path. Also, in the jam removing method according to aspects of the invention, a conveying device is typically not mounted between the pickup roller and the image forming unit of the image forming apparatus.

According to another aspect of the present invention, there is provided a jam removing device of an image forming apparatus, the image forming apparatus including: a cover unit to selectively open and close; an image forming unit to form an image on a sheet of paper conveyed along a feed path by a pickup roller; a discharging unit to discharge the paper from the image forming apparatus along a discharge path; and a driving source to drive the discharging unit, and the jam removing device including: a jam detecting unit mounted on the feed path to detect a jam on the feed path; a jam detecting unit mounted on the discharge path to detect a jam in the discharge path; a drive controlling unit to drive the driving source for a predetermined amount of time in response to opening the cover unit; and a pickup determining unit to determine performing of a pickup operation by the pickup roller according to the location of the paper.

The jam detecting unit, according to aspects of the invention, can include: a feed sensing unit, mounted on the feed path, to detect jams on the feed path; and a discharge sensing unit, mounted on the discharge path, to detect jams on the discharge path. The drive controlling unit, according to aspects of the invention, can include: an opening detecting unit to detect the cover unit being opened; and a signal generating unit to generate a jam releasing signal and to drive the driving source for a predetermined amount of time in response to the cover unit being opened. The pickup determining unit, according to aspects of the invention, can include a pickup controlling unit to operate the pickup roller where the paper is located on the feed path and to not operate the pickup roller where the paper is located on the discharge path, in response to driving the driving source. Also, in the jam removing device according to aspects of the invention, a conveying device is typically not mounted on the feed path.

According to another aspect of the present invention, there is provided an image forming apparatus, including: a cover unit to selectively open and close; an image forming unit to form an image on a sheet of paper conveyed along a feed path by a pickup roller; a discharging unit to discharge the paper from the image forming apparatus along a discharge path; a driving source to drive the discharging unit; and a jam removing device, the jam removing device including: jam detecting units which are respectively mounted on the feed path and the discharge path to detect jams in the feed path and the discharge path; a drive controlling unit to drive the driving source for a predetermined amount of time in response to opening the cover unit; and a pickup determining unit to determine performing of a pickup operation by the pickup roller according to the location of the paper.

While the invention is described in terms of jam removing devices and jam removing methods in relation to an image forming apparatus for paper copying, the invention, and aspects thereof, also applies to other types of media, such as film type media or media for overheads or transparencies, or other suitable type media for image forming, in addition to paper type media, in practice and applications of the invention. As such, references herein to paper also can correspond to other suitable medium or media, and the references to image forming apparatus can also apply to corresponding image forming apparatus, jam removing devices and jam removing methods, for other suitable media.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is shows a conventional process of removing a jam in an image forming apparatus;

FIG. 2 is a cross-sectional view of an image forming apparatus according to an embodiment of the invention;

FIGS. 3A and 3B show a jam detecting unit according to an embodiment of the invention, wherein FIG. 3A shows a state before a sheet of paper passes through the jam detecting unit, and FIG. 3B shows a state where a sheet of paper contacts the jam detecting unit;

FIG. 4 is a perspective view of a sensor unit of the jam detecting unit, according to aspects of the invention, shown in FIGS. 3A and 3B;

FIG. 5 is a perspective view of an actuator of a feed sensing unit and a discharge sensing unit according to aspects of the invention;

FIG. 6 shows the state where a jam occurs on a feed path in the image forming apparatus of FIG. 2, according to aspects of the invention;

FIG. 7 shows the state where a jam occurs over a feed path and a discharge path in the image forming apparatus of FIG. 2, according to aspects of the invention;

FIG. 8 shows the state where a jam occurs on a discharge path in the image forming apparatus of FIG. 2, according to aspects of the invention; and

FIG. 9 shows operations of a jam removing method of an image forming apparatus, according to aspects of the invention.

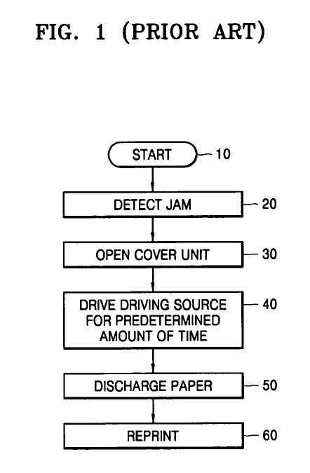

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

The exemplary embodiments relate to a jam removing device and an image forming apparatus including a jam removing device and a jam removing method according to aspects of the invention and are described, by way of example, with reference to a laser printer as an example of an image forming apparatus, although the invention is not limited in this regard. Aspects of the invention can also be applied to various other types of image forming apparatus, such as printers, inkjet printers, LED printers, digital copiers, facsimiles, and/or apparatuses which feed paper and/or other types of media.

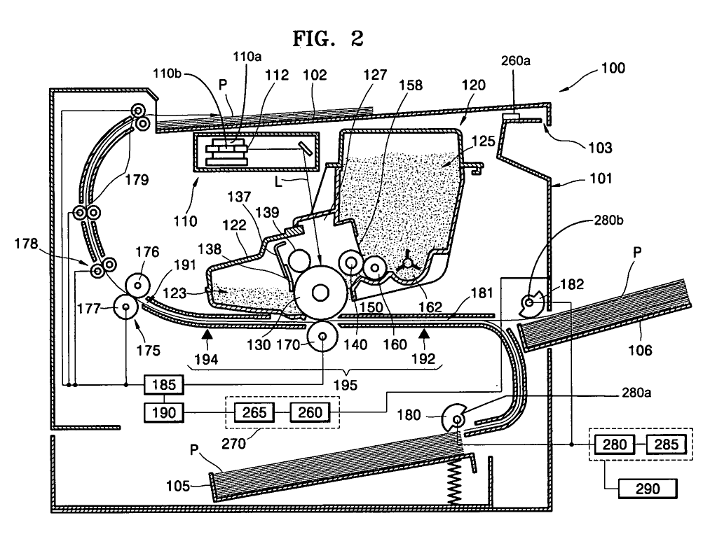

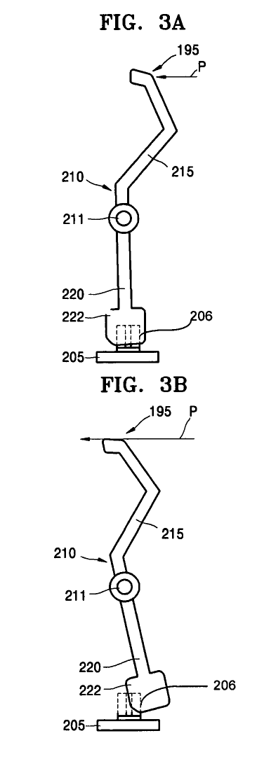

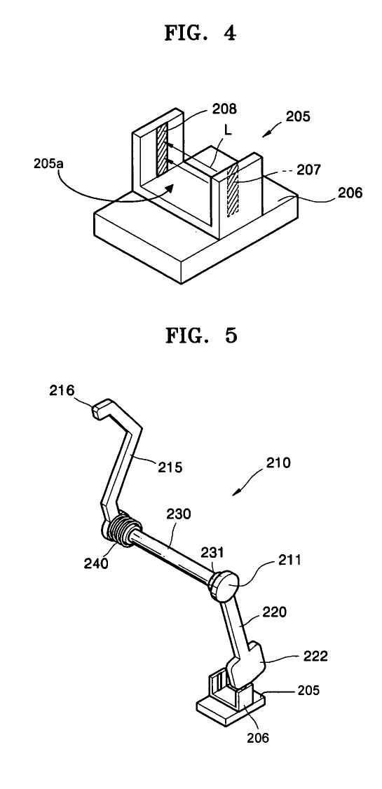

FIG. 2 is a cross-sectional view of an image forming apparatus 100 according to an embodiment of the invention. FIGS. 3A and 3B show a jam detecting unit according to an embodiment of the invention, wherein FIG. 3A shows a state before a sheet of paper passes through the jam detecting unit, and FIG. 3B shows a state where a sheet of paper contacts the jam detecting unit. FIG. 4 is a perspective view of a sensor unit of the jam detecting unit shown in FIGS. 3A and 3B, and FIG. 5 is a perspective view of an actuator of a feed sensing unit and a discharge sensing unit according to an embodiment of the invention.

Referring to FIG. 2, the image forming apparatus 100 according to an embodiment of the invention includes a frame 101 to form an outer housing, a light scanning unit 110 mounted in the frame 101, a developing cartridge 120, and a transfer roller 170 which faces a photosensitive body 130 mounted in the developing cartridge 120.

The light scanning unit 110 irradiates light L corresponding to image information onto the photosensitive body 130 according to a computer signal to form an electrostatic latent image on the surface of the photosensitive body 130. The light scanning unit 110 includes a light source 110a to irradiate laser light, and a beam, or light, deflector 110b to deflect laser light irradiated from the light source 110a. The light deflector 110b can include a polygon mirror 112 to scan the light while being rotated by a driving source, as shown in FIG. 2. Alternatively, a hologram disk, with a hologram pattern formed on its surface to diffract the light, can be used instead of the polygon mirror 112.

The developing cartridge 120 is detachably mounted in the frame 101, and includes a developing cartridge housing 122, the photosensitive body 130, a cleaning member 138, a charging roller 139, a developing roller 140, a toner layer regulating member 158, a supplying roller 160, and an agitator 162. Also, in the developing cartridge housing 122 are provided a waste toner storing unit 123 to store waste toner separated from the photosensitive body 130 by the cleaning member 138, and a toner storing unit 125 containing the toner. The developing cartridge 120 can be refilled where the toner in the toner storing unit 125 is exhausted, but need not have such a capacity in all aspects. A cover unit 103 is mounted above the frame 101 such that the developing cartridge 120 can be inserted and removed. The cover unit 103 can open and close, with the cover unit 103 being shut where closed.

The photosensitive body 130 rotates, and a portion of its surface is exposed. The photosensitive body 130 is typically a cylindrical metal drum coated with an optical conductive material layer by a deposition method, but can be of other materials and/or shapes. The photosensitive body 130 is charged by the charging roller 139, and an electrostatic latent image corresponding to an image to be printed is formed on the surface of the photosensitive body 130 by the light L irradiated from the light scanning unit 110. In order to charge the surface of the photosensitive body 130 to a uniform potential, a charging bias voltage is applied to the charging roller 139. Instead of the charging roller 139, a corona charging unit can be employed.

The developing roller 140 supplies toner to the photosensitive body 130. The developing roller 140 contains powdered toner and supplies the toner to the electrostatic latent image formed on the photosensitive body 130 to form a toner image. A developing bias voltage to supply the toner to the photosensitive body 130 is applied to the developing roller 140. In the exemplary embodiment, the developing roller 140 is obtained by nickel (Ni) plating a sandblasted aluminum (Al) core. Alternatively, the developing roller 140 can be obtained by covering a stainless steel shaft with rubber about 1 mm thick, for example.

The supplying roller 160 supplies the toner to the developing roller 140. The agitator 162 agitates the toner so that the toner in the toner storing unit 125 does not harden, and moves the toner toward the supplying roller 160. The toner layer regulating member 158 controls the thickness of the toner attached to the surface of the developing roller 140.

The cleaning member 138 is mounted in the housing 122 with one end contacting the photosensitive body 130. The cleaning member 138 removes the toner left on the photosensitive body 130 after the transfer operation. One side of the cleaning member 138 can be mounted on a support member 137 which is separately mounted in the housing 122. The other side of the cleaning member 138 contacts the photosensitive body 130 to remove the toner left on the photosensitive body 130 after the transfer operation. The waste toner storing unit 123 is provided in the developing cartridge 120 and stores the toner removed from the photosensitive body 130 by the cleaning member 138.

The developing cartridge 120 of the exemplary embodiment includes an opening 127 to form a passage by which the light irradiated by the light scanning unit 110 is irradiated onto the photosensitive body 130. The exposed surface of the photosensitive body 130 faces the transfer roller 170.

A transfer bias voltage having the opposite polarity to the toner image is applied to the transfer roller 170 such that the toner image formed on the photosensitive body 130 is transferred onto a sheet of paper R The toner image is transferred onto the paper P by an electrostatic force generated between the photosensitive body 130 and the transfer roller 170. Alternatively, the toner image can be transferred onto the paper P passing the transfer roller 170 and the photosensitive body 130 by contact pressure between the transfer roller 170 and the photosensitive body 130.

A fixing unit 175 includes a pair of fixing rollers 176 and 177 which rotate while facing each other and apply heat and pressure to the toner image transferred on the paper P, to fix the toner image on the paper P. The fixing roller 176 is a heat roller to apply heat to the paper P such that the toner image is permanently fixed to the paper P. The fixing roller 177 faces the fixing roller 176 and is a pressure roller to apply high pressure to the paper P to fix the toner image to the paper P. Discharging rollers 178 and 179 are further included in the image forming apparatus 100 to discharge the paper P with the toner image from the image forming apparatus 100. The paper P is discharged from the image forming apparatus 100 into a discharging tray 102.

A discharging unit 185 to discharge the paper P from the image forming apparatus 100 along a discharge path 191 includes the transfer roller 170, the fixing rollers 176 and 177, and the discharging rollers 178 and 179. The discharge path 191 is a conveying path on which the paper P passing through an image forming unit 150 is discharged from the image forming apparatus 100. The discharging unit 185 is driven by a driving source 190, such as a motor or other suitable driving device.

Furthermore, the image forming apparatus 100 includes first and second feed cassettes 105 and 106 which are mounted below the frame 101 and load the paper P. Pickup rollers 180 and 182 are respectively mounted above the first and second feed cassettes 105 and 106, and rotate while pressing one surface of the loaded paper P to convey the paper P to the image forming unit 150. The pickup roller 180 or 182 picks up the sheets of paper P one by one to convey them to the image forming unit 150. The paper P is conveyed to the image forming unit 150 by the pickup roller 180 or 182 along the feed path 181. The feed path 181 is a conveying path on which the paper P picked up by the pickup roller 180 or 182 is conveyed to the image forming unit 150. However, it is understood that plural pickup rollers 180, 182 need not be used in all aspects, such as where multiple trays or cassettes to contain the paper P are not used.

The image forming unit 150 of the exemplary embodiment includes the developing cartridge 120 and the transfer roller 170. The image forming unit 150 transfers the toner image to the paper P which is conveyed by the pickup roller 180 or 182 along the feed path 181 to form an image on the paper P. In a shuttle type inkjet printer, for example, the image forming unit typically is a head to emit ink onto the paper P to print an image on the paper P, and in the line printing type inkjet printer, the image forming unit is typically an inkjet head which has a nozzle as wide as the paper P

One or more jam detecting units 195 are respectively mounted on one or both of the conveying paths, such as the feed path 181 and the discharge path 191, and the jam detecting unit(s) 195 detect(s) where the conveyed paper P jams. Also, a single jam detecting unit 195 can be associated with both the feed path 181 and the discharge path 181. The shown jam detecting unit 195 associated with the feed path 181 includes a feed sensing unit 192 mounted on the feed path 181, and a jam detecting unit 195 associated with the discharge path 191 includes a discharge sensing unit 194 mounted on the discharge path 191. However, the jam detecting unit(s) 195 can be otherwise disposed to sense jams at or along the conveying path or other paths. The feed sensing unit 192 is selectively turned on and off according to the paper P conveyed along the feed path 181, and the feed sensing unit 192 detects the conveyance and the jam of the paper P which is conveyed along the feed path 181 by the pickup rollers 180 and 182. The discharge sensing unit 194 is selectively turned on and off according to the paper P conveyed along the discharge path 191, and the discharge sensing unit 194 detects the conveyance and the jam of the paper P which is conveyed along the discharge path 191 where the paper P has passed through the image forming unit 150.

A jam detecting method to detect a jam, according to aspects of the invention, is described by reference to the image forming apparatus 100 including the jam detecting unit(s) 195. As to the detecting of the paper P by the jam detecting unit(s) 195, a state where the paper P respectively passes through the feed sensing unit 192 and/or the discharge sensing unit 194 of the corresponding jam detecting unit(s) 195 is defined as an ON state, and the state where the paper P is not located on the feed sensing unit 192 and/or the discharge sensing unit 194 of the corresponding jam detecting unit(s) 195 is defined as an OFF state, although the invention is not limited in this regard.

Where the front end of the paper P passes through the feed sensing unit 192, the feed sensing unit 192 is turned on and is in the ON state. In a normal conveyance of the paper P, after a predetermined amount of time elapses, the feed sensing unit 192 is turned off. The predetermined amount of time is an amount of time that elapses from the front end of the paper P passing through the feed sensing unit 192 turning on the feed sensing unit 192 to the trailing edge of the paper P passing through the feed sensing unit 192 turning off the feed sensing unit 192, during a normal conveyance of the paper P, but can be otherwise defined. However, where a jam occurs on the feed path 181, the paper P is not conveyed. Accordingly, even after the predetermined amount of time elapses, the feed sensing unit 192 is not turned off, indicating the presence of a jam in the feed path 181.

Where the front end of the paper P passes through the discharge sensing unit 194, the discharge sensing unit 194 is turned on and is in the ON state. In a normal conveyance of the paper P, after a predetermined amount of time elapses, the discharge sensing unit 194 is turned off. The predetermined amount of time is an amount of time that elapses from the front end of the paper P passing through the discharge sensing unit 194 turning on the discharge sensing unit 194 to the trailing edge of the paper P passing through the discharge sensing unit 194 turning off the discharge sensing unit 194, during a normal conveyance of the paper P, but can be otherwise defined. Also, the predetermined amount of time that elapses where the paper P passes through the discharge sensing unit 194, can be the same or different from the predetermined amount of time that elapses where the paper P passes through the feed sending unit 192 during a normal conveyance of the paper P. However, where a jam occurs on the discharge path 191, the paper P is not conveyed. Accordingly, even after the predetermined amount of time elapses, the discharge sensing unit 194 is not turned off, indicating the presence of a jam in the discharge path 191. The corresponding jam detecting unit(s) 195 thus selectively detect(s) whether a jam occurs on the feed path 181 and/or the discharge path 191.

Referring to FIGS. 3A and 3B, the feed sensing unit 192 and the discharge sensing unit 194, which serve as the jam detecting unit(s) 195, include a sensing unit 205 to detect the conveyance of the paper P and the jam of the paper P, and an actuator 210 to selectively turn the sensing unit 205 on/off to indicate the presence or absence of a jam occurring where conveying the paper P in the feed path 181 and/or the discharge path 191.

Referring to FIGS. 3A, 3B and 4, the sensing unit 205 includes a sensor 206 which is selectively turned on and off in connection with the rotation of a sensor operating arm 220. As an example, the sensor 206 can be an optical sensor including a light emitting unit 207 and a light receiving unit 208 which are separated from each other at both sides of a path 205a through which a light shielding unit 222 formed on the end of the sensor operating arm 220 rotates. The light L′ is emitted by the emitting unit 207 and received by the light receiving unit 208, with the light L′ emitted from the light emitting unit 207 being transmitted to the light receiving unit 208 across the path through which passes the light shielding unit 222. Where the light shielding unit 222 is located between the light emitting unit 207 and the light receiving unit 208, the amount of the light transmitted to the light receiving unit 208 is changed indicating a change of state of the ON/OFF state of the sensing unit 205. Thus, the normal conveyance of the paper P or a jam of the paper P is detected by the respective jam detecting unit(s) 195.

Referring to FIG. 5, the actuator 210 can rotate around a point or pivot member 211. The actuator 210 has a paper contact arm 215 to contact the paper P conveyed along the conveyance path, and a sensor operating arm 220 which rotates together with the paper contact arm 215 in response to the paper contact arm 215 contacting the paper P.

The paper contact arm 215, for example, is rotatably mounted on the main frame 101. As an example, the paper contact arm 215 can be mounted on a rotating member 230 which is rotatably mounted on the frame 101. One end 216 of the paper contact arm 215 is extended to the conveying path of the paper P. Initially, the paper contact arm 215 is positioned to interrupt the conveying path of the paper P. Where the paper P is conveyed along the conveying path, the front end of the paper P pushes and rotates the paper contact arm 215. An elastic member 240 is wound on the rotating member 230. The elastic member 240 elastically biases the paper contact arm 215 so that the paper contact arm 215 rotates towards the paper P. In this regard, the elastic member 240 provides a restoring force to return the paper contact arm 215 to its initial location or position. After the trailing edge of the paper P passes the paper contact arm 215, the paper contact arm 215 is rotated by the restoring force of the elastic member 240 to return to its initial location or position.

The sensor operating arm 220 is mounted on the end 231 of the rotating member 230. The sensor operating arm 220 rotates together with the paper contact arm 215 and selectively turns the sensing unit 205 on and off according to the paper P conveyed along the conveying path to indicate a normal conveyance or a jam of the paper P. The light shielding unit 222 to selectively turn the sensing unit 205 on and off is mounted on one end of the sensor operating arm 220, and the light shielding unit 222 correspondingly moves with the sensor operating arm 220 to selectively turn the sensing unit 205 on and off. However, it is understood that other sensing units can be used, such as optical sensors which do not contact the paper P and detect where the paper P passes between an emitter and a detector.

A drive controlling unit 270 controls operations of the image forming apparatus 100. The drive controlling unit 270 can be a processing device, such as a processor, microprocessor or an application specific integrated circuit (ASIC), with associated memory and software or programming, to control operations of the image forming apparatus 100 and the jam detection operations. The driving controlling unit 270 includes an opening detecting unit 260 and a signal generating unit 265, and the driving controlling unit 270 drives the driving source 190 for a predetermined amount of time by opening the cover unit 103. The opening detecting unit 260 detects whether the cover unit 103 is opened or closed. Where it is determined that the cover unit 103 is opened, the signal generating unit 265 generates a jam releasing signal to drive the driving source 190. The opening detecting unit 260 detects whether the cover unit 103 is opened by receiving a corresponding communication, such as a signal, from an opening detecting sensor 260a, such an optical sensing device, electromechanical sensing device or other suitable detecting device to sense the open and closed state of the cover unit 103.

Where the cover unit 103 is opened, the signal generating unit 265 generates the jam releasing signal to drive the driving source 190, which operates the discharging unit 185. By operating the discharging unit 185 for a predetermined amount of time, the location of the jammed paper P can be changed according to the location of the paper P. Where the jammed paper P is located on the feed path 181, the location of the paper P is not changed, even though the discharging unit 185 operates. Where the jammed paper P is located on the discharge path 191, the paper P is discharged from the image forming apparatus 100 or the ON/OFF state of the feed sensing unit 192 and/or the discharge sensing unit 194 is changed by operating the discharging unit 185. Accordingly, where the cover unit 103 is opened, the driving source 190 can be controlled so that the discharging unit 185 operates during a time where the paper P, in response to operation of the discharging unit 185, can change the ON/OFF state of the feed sensing unit 192 and/or the discharge sensing unit 194. However, it is possible that the jam releasing signal can be generated according to an input other than by opening the cover unit 103, such as by depression of a button or by removal of a paper tray or cassette.

A pickup determining unit 290 includes a pickup driving unit 280 to operate the pickup rollers 180 and 182, and a pickup controlling unit 285 to control the pickup driving unit 280, and to determine the operation of the pickup roller 180 or 182 according to the location of the jammed paper P. The pickup controlling unit 285 can be a processing device, such as a processor, microprocessor or an application specific integrated circuit (ASIC), with associated memory and software or programming, to control operations of the pickup determining unit 290 and the jam detection operations. The pickup driving unit 280 operates the pickup rollers 180 and 182 by selectively driving sources 280a and 280b, such as motors, solenoids or other suitable driving devices, so that the paper P is picked up and then conveyed along the feed path 181. The pickup controlling unit 285 controls the pickup driving unit 280 so that the pickup roller 180 or 182 operates where the paper P is located on the feed path 181, and the pickup controlling unit 285 controls the pickup driving unit 280 so that the pickup roller 180 or 182 does not operate where the paper P is located on the discharge path 191, based on the information detected by the jam detecting unit(s) 195.

Where a jam occurs during conveying of the paper P, the cover unit 103 is opened so as to remove the jammed paper P. In response, the driving source 190 operates the discharging unit 185, and the jam detecting unit(s) 195 detect(s) the location of the jammed paper P. The pickup determining unit 290 determines whether to perform a pickup operation to convey the jammed paper P by the pickup roller 180 or 182 according to the location of the jammed paper P detected by the jam detecting unit(s) 195. In this regard, where the paper P is located on the feed path 181, the pickup determining unit 290 operates the pickup roller 180 or 182 to convey the jammed paper P, and, where the jammed paper P is located on the discharge path 191, the pickup determining unit 290 does not operate the pickup roller 180 or 182.

For example, in response to the jam occurring on the feed path 181, the corresponding pickup roller 180 or 182 operates to convey the jammed paper P, and thus the jammed paper P is conveyed to the discharge path 191 through the image forming unit 150 by the operation of the corresponding pickup roller 180 or 182. Where the jam occurs on the discharge path 191, the paper P is discharged from the image forming apparatus 100 and/or moves on the discharge path 191 by the driving source 190 being driven in response to the cover unit 103 being opened. Where the paper P is located on the discharge path 191, the discharging unit 185 is driven, and thus the paper P is discharged from the image forming apparatus 100. The jammed paper P on the feed path 181 or the discharge path 191 can be removed by one or more of these operations. In the image forming apparatus 100 of the invention, a conveying device to convey the paper P is not necessarily mounted between the pickup rollers 180 and 182 and the image forming unit 150 in that, according to aspects of the invention, the jammed paper P typically can be removed even though a conveying device is not mounted on the feed path 181.

The operation of the jam removing device including the jam detecting unit(s) 195, the image forming apparatus 100 including the exemplary jam removing device, and the exemplary jam removing method of an image forming apparatus, such as the image forming apparatus 100, according to aspects of the invention, is further described with reference to the image forming apparatus 100 with reference to FIGS. 2 through 9. Referring again to FIG. 2, the photosensitive body 130 of the developing cartridge 120 is charged to a uniform potential by a charging bias voltage applied to the charging roller 139. The light scanning unit 110 irradiates light corresponding to image information onto the photosensitive body 130 of the developing cartridge 120 through the opening 127. Where the light is irradiated, only the irradiated portion of the photosensitive body 130 is discharged, and thus the electrostatic latent image is formed by the potential difference.

The toner in the toner storing unit 125 is agitated by the agitator 162 and is supplied to the developing roller 140 to which the developing bias voltage is applied, such as by the supplying roller 160. The toner layer regulating member 158 regulates the toner layer attached to the surface of the developing roller 140 in a thin layer of uniform thickness. The toner is rubbed and charged by the developing roller 140 and the toner layer regulating member 158. The toner attached to the surface of the developing roller 140 is transferred to the electrostatic latent image formed on the peripheral surface of the photosensitive body 130, and thus the toner image is formed on the photosensitive body 130.

The paper P is picked up from the feed cassette 105 or 106 by the pickup rollers 180 or 182. The paper P passes between the photosensitive body 130 and the transfer roller 170 by the conveying force of the pickup rollers 180 or 182. At this time, where the transfer bias voltage is applied to the transfer roller 170, the toner image formed on the photosensitive body 130 is transferred onto the paper P.

After the transfer operation, the toner left on the surface of the photosensitive body 130 is removed by the cleaning member 138 and stored in the waste toner storing unit 123. The fixing rollers 176 and 177 apply heat and pressure to the toner image formed on the paper P to fix the toner image to the paper P. The paper P passing through the fixing rollers 176 and 177 is discharged from the image forming apparatus 100 by the discharging rollers 178 and 179 of the discharging unit 185 and loaded onto the discharging tray 102.

In the operations of forming the image on the paper P, typically the paper P passes through the feed path 181 and the discharge path 191 and is normally conveyed. On the other hand, the paper P can jam on the feed path 181 or the discharge path 191. First, where the paper P is conveyed normally is described. The front end of the paper P which is picked up by the pickup roller 180 or 182 pushes the paper contact arm 215, which is initially positioned to interrupt the feed path 181, and then rotates the paper contact arm 215. The sensor operating arm 220 rotates together with the paper contact arm 215, and thus the light shielding unit 222 located in the sensing unit 205 of the feed sensing unit 192 rotates (FIG. 3A to FIG. 3B). By rotating the light shielding unit 222, which interrupts the path of the light from the light emitting unit 207 to the light receiving unit 208, the sensing unit 205 of the feed sensing unit 192 is turned on. By way of example, the state where the light shielding unit 222 does not interrupt the path of the light from the light emitting unit 207 to the light receiving unit 208 is referred to as the ON state, and the state where the light shielding unit 222 does interrupt the path of the light from the light emitting unit 207 to the light receiving unit 208 is referred to as the OFF state.

Where the paper P is conveyed, the paper contact arm 215 is pushed, and thus the sensing unit 205 is held in the ON state for a predetermined amount of time. Where the paper P is continuously conveyed to release the contact between the trailing edge of the paper P and the paper contact arm 215, the light shielding unit 222 returns to its initial state, and thus the sensing unit 205 of the feed sensing unit 192 is turned off placing the sensing unit 205 in the OFF state (FIG. 3B to FIG. 3A). Where the paper P passes through the image forming unit 150, the paper P is conveyed along the discharge path 191 by the discharging unit 185 including the transfer roller 170.

Similar to the operation of the feed sensing unit 192, where the paper P is conveyed along the discharge path 191, the operation of the discharge sensing unit 194 is the same, or similar, to the operation of the feed sensing unit 192. In this regard, by way of example, in the operation of the discharge sensing unit 194, the front end of the paper P, where conveyed along the discharge path 191, pushes the paper contact arm 215, which is initially positioned to interrupt the feed path 181, and then rotates the paper contact arm 215. The sensor operating arm 220 rotates together with the paper contact arm 215, and thus the light shielding unit 222 located in the sensing unit 205 of the discharge sensing unit 194 rotates (FIG. 3A to FIG. 3B). By rotating the light shielding unit 222, which interrupts the path of the light from the light emitting unit 207 to the light receiving unit 208, the sensing unit 205 is turned on. Where the paper P is conveyed along the discharge path 191, the paper contact arm 215 is pushed, and thus the sensing unit 205 is held in the ON state for a predetermined amount of time. Where the paper P is continuously conveyed to release the contact between the trailing edge of the paper P and the paper contact arm 215, the light shielding unit 222 returns to its initial state, and thus the sensing unit 205 of the discharge sensing unit 194 is turned off placing the sensing unit 205 in the OFF state (FIG. 3B to FIG. 3A).

Where the paper P is conveyed normally, the feed sensing unit 192 or the discharge sensing unit 194 is selectively turned on/off after a predetermined amount of time. In this regard, where the paper P is conveyed normally, the front end of the paper P turns on the feed sensing unit 192 and/or the discharge sensing unit 194. Where the paper P is continuously conveyed, the rear end of the paper P is conveyed, and thus the feed sensing unit 192 and/or the discharge sensing unit 194 are turned off. According to aspects of the invention, the order that the feed sensing unit 192 is selectively turned on/off and the order that the discharge sensing unit 194 is selectively turned on/off can be different, such as according to the size of the paper P and/or the structure of the image forming apparatus 100.

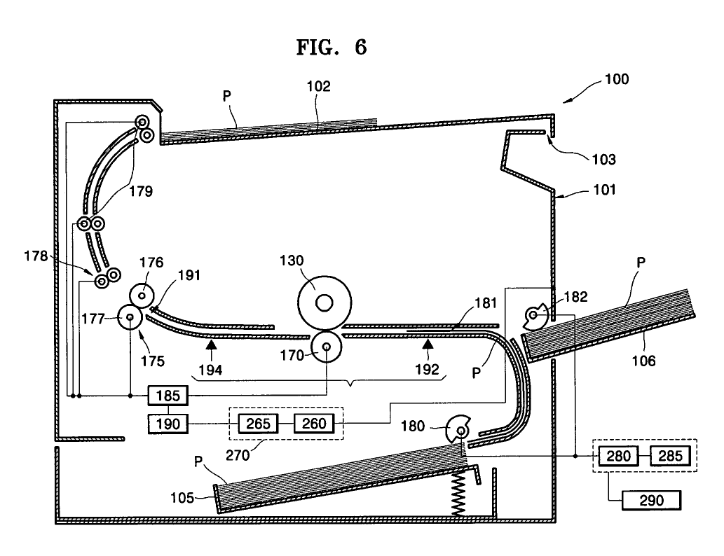

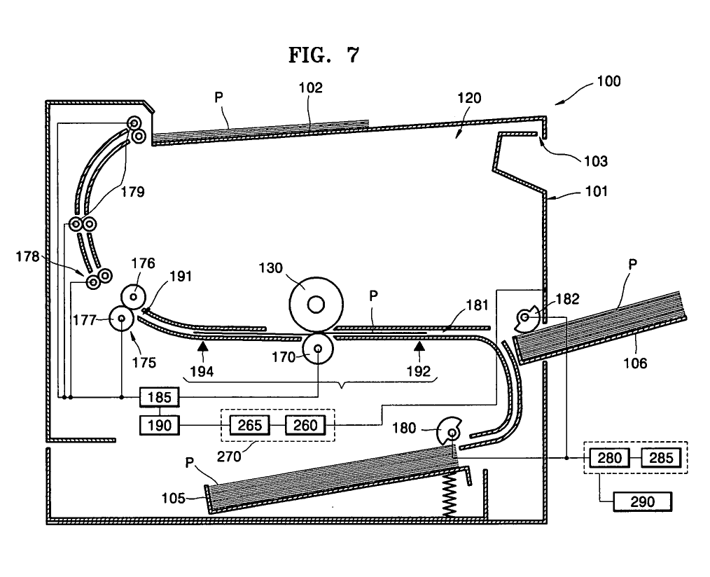

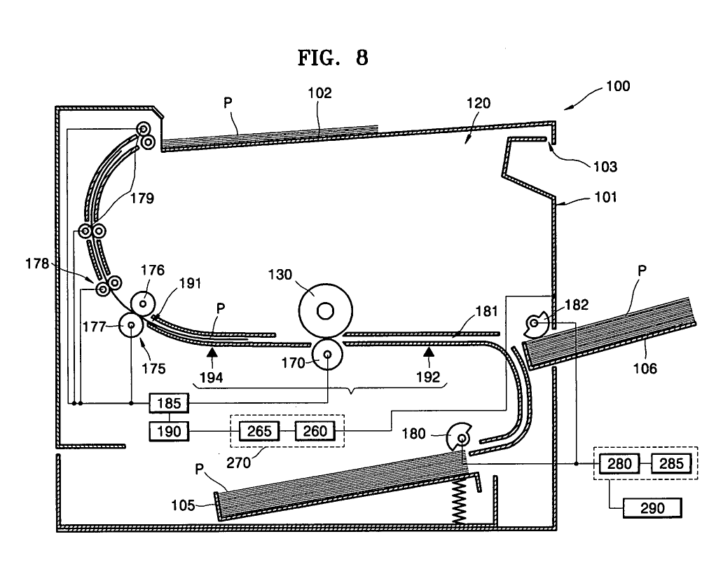

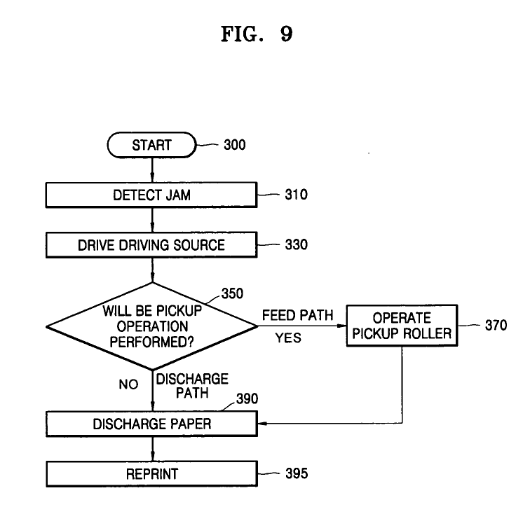

Referring to FIGS. 6 through 8, there are illustrated examples where the paper P is not conveyed normally, such as where a jam occurs on the feed path 181 or the discharge path 191. Where a jam of the paper P has occurred, since the paper P can not be conveyed normally along the conveying path, the feed sensing unit 192 and/or the discharge sensing unit 194 are not selectively turned on/off normally. For example, FIG. 6 shows the state in which the feed sensing unit 192 is held in the ON state (the paper P jams in the feed path 181), FIG. 7 shows the state in which the feed sensing unit 192 and the discharge sensing unit 194 are both held in the ON state (the paper P jams in both the feed path 181 and the discharge path 191), and FIG. 8 shows the state in which the discharge sensing unit 194 is held in the ON state (the paper P jams in the discharge path 191).

A method of removing jammed paper P from the feed path 181 and/or the discharge path 191, according to aspects of the invention, is described with reference to FIG. 9. FIG. 9 illustrates jam removing operations of the image forming apparatus, such as the image forming apparatus 100, according to the invention. In the jam removing operations, the jam detecting unit(s) 195 detect(s) the jamming of the paper P (operation 310). In the operation 310, the jam detecting unit(s) 195 determine(s) whether the feed sensing unit 192 and/or the discharge sensing unit 194 are selectively turned on/off normally or not normally to detect the jam of the paper P.

Where a jam of the paper P is detected by the jam detecting unit(s) 195, the driving source 190 is driven for a predetermined amount of time (operation 330). By way of example, where the driving source 190 is driven in connection with the operation of opening the cover unit 103, the driving source 190 is driven for a predetermined amount of time in response to the jam releasing signal generated in response to opening the cover unit 103. The operation to generate the jam releasing signal includes an operation to detect where the cover unit 103 is opened by the opening detecting unit 260, and an operation to generate the jam releasing signal by the signal generating unit 265 where the cover unit 103 is opened.

Also, where a jam has occurred, performing a pickup operation of the pickup roller 180 or 182, such as to convey the jammed paper P, is determined according to the location of the jammed paper P (operation 350). The operation 350 of determining to perform a pickup operation, such as to convey the jammed paper P by the corresponding pickup roller 180 or 182, further includes the operation of detecting the location of the jammed paper P by the jam detecting unit(s) 195 where the driving source 190 is driven.

Where the jam of the paper P is generated on the feed path 181, such as shown in FIG. 6, the location of the jammed paper P is not changed even though the driving source 190 is driven. However, where the jam of the paper P is generated on the discharge path 191 as shown in FIGS. 7 and 8, the location of the jammed paper P changes where the driving source 190 is driven. In this regard, where the paper P is jammed on the feed path 181, such as shown in FIG. 6, the pickup roller 180 or 182 to provide the conveying force to the jammed paper P does not operate, even though the driving source 190 is driven, and thus the location of the jammed paper P does not change where the driving source 190 is driven. However, where the paper P is jammed on the discharge path 191, such as shown in FIGS. 7 and 8, the discharging unit 185 driven by the driving source 190 conveys the jammed paper P, and thus the location of the jammed paper P changes in the conveying path, such as in the discharge path 191.

Where the driving source 190 is driven for the predetermined amount of time, the pickup determining unit 290 determines performing a pickup operation to convey the jammed paper P by the corresponding pickup roller 180 or 182 according to the location of the jammed paper P. Where the jammed paper P is located on the feed path 181 in response to the driving source 190 being driven, the pickup determining unit 290 operates the corresponding pickup roller 180 or 182 to perform a pickup operation, such as to convey the jammed paper P by the corresponding pickup roller 180 or 182 (operation 370). For example, where the signal of the feed sensing unit 192 is not changed after the driving source 190 is driven, the jammed paper P is conveyed by the operation of the corresponding pickup roller 180 or 182, in that the signal of the feed sensing unit 192 is not changed where the jammed paper P is located between the pickup rollers 180 and 182 and the image forming unit 150.

Accordingly, by operating the corresponding pickup roller 180 or 182, the jammed paper P is conveyed into the image forming unit 150 through the feed path 181 by the conveying force of the pickup roller 180 or 182. By driving the discharging unit 185, the jammed paper P is discharged from the image forming apparatus 100 by the discharging unit 185 (operation 390). Where the pickup rollers 180 or 182 do not operate, where the jammed paper is located in the feed path 181, the jammed paper P is not removed. Accordingly, by operating the corresponding pickup roller 180 or 182, the jammed paper P in the feed path 181 is removed and a reprinting operation can be performed (operation 395).

Where the paper P is located on the discharging path 191 after the driving source 190 is driven for the predetermined amount of time, the pickup determining unit 290 does not operate the pickup roller 180 or 182. For example, where the discharge sensing unit 194 is turned on, such as for the jammed paper P illustrated in FIGS. 7 and 8, or the feed sensing unit 192 is turned off, such as illustrated in FIG. 8, after the driving source 190 is driven, the pickup determining unit 290 does not operate the pickup roller 180 or 182, in that a double pickup can occur where the pickup roller 180 or 182 operated. Therefore, by driving the discharging unit 185 to remove the jammed paper P at operation 390, the jammed paper P can be discharged from the image forming apparatus 100, and then the reprinting operation can be performed (operation 395).

According to the above-mentioned aspects of the invention, in an image forming apparatus including a jam removing device according to the invention, a conveying device does not necessarily need to be mounted on the feed path 181. Also, according to aspects of the invention, the pickup rollers 180 and 182 can selectively operate according to the location of the jammed paper P.

Also, according to aspects of the invention, since a conveying device is not necessarily mounted on the feed path in the invention, the manufacturing cost of an image forming apparatus can be reduced. Further, where the jammed paper is located on the feed path of an image forming apparatus, the jammed paper can be efficiently removed where a conveying device is not mounted on the feed path. Moreover, where the jammed paper is located on the discharge path, the double pickup of a new paper can be prevented by controlling the operation of the pickup roller. Further, by selectively operating the pickup roller according to the location of the jammed paper to efficiently remove the jammed paper, inconvenience to the user can be prevented and after-service due to the occurrence of jams can be reduced, thereby promoting an increase in the reliability of the product.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A jam removing method of an image forming apparatus, the image forming apparatus comprising a cover unit to selectively open and close, an image forming unit to form an image on a sheet of paper conveyed along a feed path by a pickup roller, a discharging unit to discharge the paper from the image forming apparatus along a discharge path, a driving source to drive the discharging unit, and a jam detecting unit, mounted on a conveying path of the paper, to detect a jam, the jam removing method comprising:
detecting a jam of the paper in the image forming apparatus by the jam detecting unit;
driving the driving source for a predetermined amount of time, in response to the jam of the paper occurring in the image forming apparatus;
selectively performing a pickup operation by the pickup roller according to a detected location of the jammed paper; and
discharging the jammed paper from the image forming apparatus by the discharging unit.

2. The jam removing method according to claim 1, wherein the detecting of the jam by the jam detecting unit comprises:
detecting the jam of the paper on the feed path by a feed sensing unit of the jam detecting unit, mounted on the feed path, and detecting the jam of the paper on the discharge path by a discharge sensing unit of the jam detecting unit, mounted on the discharge path.

3. The jam removing method according to claim 2, wherein the selectively performing the pickup operation further comprises:
detecting the location of the jammed paper by the jam detecting unit, in response to the jam of the paper occurring in the image forming apparatus, by driving the driving source for the predetermined amount of time.

4. The jam removing method according to claim 3, further comprising:
controlling the pickup roller to operate, where the jammed paper is located only on the feed path, in response to detecting the location of the jammed paper in the image forming apparatus.

5. The jam removing method according to claim 3, further comprising:
controlling the pickup roller to not operate, where at least a portion of the jammed paper is located on the discharge path, in response to detecting the location of the jammed paper in the image forming apparatus.

6. The jam removing method according to claim 3, wherein:
a conveying device, to convey the paper, is not mounted in the feed path between the pickup roller and the image forming unit.

7. The jam removing method according to claim 1, wherein the driving the driving source further comprises:
generating a jam releasing signal by opening the cover unit of the image forming apparatus; and
driving the driving source in response to the jam releasing signal being generated by opening the cover unit.

8. The jam removing method according to claim 7, wherein the generating the jam releasing signal comprises:
detecting the opening of the cover unit by an opening detecting unit; and
generating the jam releasing signal by a signal generating unit, where the opening of the cover unit is detected.

9. A jam removing device of an image forming apparatus, the image forming apparatus comprising:
a cover unit to selectively open and close;
an image forming unit to form an image on a sheet of paper conveyed along a feed path by a pickup roller;
a discharging unit to discharge the paper from the image forming apparatus along a discharge path; and
a driving source to drive the discharging unit, and the jam removing device comprising:
a jam detecting unit, mounted on the feed path and the discharge path, to detect a jam of the paper in the image forming apparatus;
a drive controlling unit to drive the driving source for a predetermined amount of time by opening of the cover unit; and
a pickup determining unit to determine selectively performing a pickup operation by the pickup roller according to a detected location of the jammed paper.

10. The jam removing device according to claim 9, wherein the drive controlling unit comprises:
an opening detecting unit to detect the opening of the cover unit; and
a signal generating unit to generate a jam releasing signal and to drive the driving source for the predetermined amount of time, where the opening of the cover unit is detected by the opening detecting unit.

11. The jam removing device according to claim 10, wherein:
a conveying device, to convey the paper, is not mounted on the feed path.

12. The jam removing device according to claim 9, wherein the jam detecting unit comprises:
a feed sensing unit, mounted on the feed path, to detect the jam of the paper on at least a portion of the feed path; and
a discharge sensing unit, mounted on the discharge path, to detect the jam of the paper on at least a portion of the discharge path.

13. The jam removing device according to claim 12, wherein the pickup determining unit comprises:
a pickup controlling unit to operate the pickup roller, where the jammed paper is located only on the feed path, and to not operate the pickup roller, where at least a portion of the jammed paper is located on the discharge path.

14. The jam removing device according to claim 13, wherein:
a conveying device, to convey the paper, is not mounted on the feed path.

15. An image forming apparatus, including:
a cover unit to selectively open and close;
an image forming unit to form an image on a sheet of paper conveyed along a feed path by a pickup roller;
a discharging unit to discharge the paper from the image forming apparatus along a discharge path;
a driving source to drive the discharging unit; and
a jam removing device, the jam removing device comprising:
a jam detecting unit, mounted on the feed path and the discharge path, to detect a jam of the paper in the image forming apparatus;
a drive controlling unit to drive the driving source for a predetermined amount of time by opening of the cover unit; and
a pickup determining unit to determine selectively performing a pickup operation by the pickup roller according to a detected location of the jammed paper in the image forming apparatus.

16. The image forming apparatus according to claim 15, wherein the drive controlling unit comprises:
an opening detecting unit to detect the opening of the cover unit; and
a signal generating unit to generate a jam releasing signal and to drive the driving source for the predetermined amount of time in response to the cover unit being opened.

17. The image forming apparatus according to claim 16, wherein:
a conveying device, to convey the paper, is not mounted on the feed path.

18. The image forming apparatus according to claim 15, wherein the jam detecting unit comprises:
a feed sensing unit, mounted on the feed path, to detect the jam of the paper on at least a portion of the feed path; and
a discharge sensing unit, mounted on the discharge path, to detect the jam of the paper on at least a portion of the discharge path.

19. The image forming apparatus according to claim 18, wherein the pickup determining unit comprises:
a pickup controlling unit to operate the pickup roller, where the jammed paper is located only on the feed path, and to not operate the pickup roller, where at least a portion of the jammed paper is located on the discharge path.

20. The image forming apparatus according to claim 19, wherein:
a conveying device, to convey the paper, is not mounted on the feed path.

21. The image forming apparatus according to claim 16, wherein the jam detecting unit comprises:
a feed sensing unit, mounted on the feed path, to detect the jam of the paper on at least a portion of the feed path; and
a discharge sensing unit, mounted on the discharge path, to detect the jam of the paper on at least a portion of the discharge path.

22. The image forming apparatus according to claim 21, wherein the pickup determining unit comprises:
a pickup controlling unit to operate the pickup roller, where the jammed paper is located only on the feed path, and to not operate the pickup roller, where at least a portion of the jammed paper is located on the discharge path.

23. The image forming apparatus according to claim 22, wherein:
a conveying device, to convey the paper, is not mounted on the feed path.

24. The jam removing device according to claim 13, wherein the drive controlling unit comprises:
an opening detecting unit to detect the opening of the cover unit; and
a signal generating unit to generate a jam releasing signal and to drive the driving source for the predetermined amount of time, where the opening of the cover unit is detected by the opening detecting unit.

25. The jam removing device according to claim 24, wherein:
a conveying device, to convey the paper, is not mounted on the feed path.

26. The jam removing method according to claim 3, wherein the driving the driving source further comprises:
generating a jam releasing signal by opening the cover unit of the image forming apparatus; and
driving the driving source in response to the jam releasing signal being generated by opening the cover unit.

27. The jam removing method according to claim 26, wherein the generating the jam releasing signal comprises:
detecting the opening of the cover unit by an opening detecting unit; and
generating the jam releasing signal by a signal generating unit, where the opening of the cover unit is detected.

28. The jam removing method according to claim 27, further comprising:
controlling the pickup roller to operate, where the jammed paper is located only on the feed path; and
controlling the pickup roller to not operate, where at least a portion of the jammed paper is located on the discharge path.

29. The jam removing method according to claim 28, wherein:
a conveying device, to convey the paper, is not mounted in the feed path between the pickup roller and the image forming unit.

30. A jam removing method of an image forming apparatus, comprising:
detecting a jam of the paper in a conveying path of the image forming apparatus, the conveying path comprising a first path and a second path;
driving a driving source of a discharging unit of the image forming apparatus for a predetermined amount of time, in response to the jam of the paper occurring in the conveying path of the image forming apparatus;
selectively performing a pickup operation by a pickup roller of the image forming apparatus, according to a detected location of the jammed paper relative to the first and second paths, in response to driving the driving source for the predetermined amount of time; and
discharging the jammed paper from the image forming apparatus by the discharging unit.

31. The jam removing method according to claim 30, wherein the detecting the jam of the paper in the conveying path comprises:
detecting the jam of the paper on the first path by a feed sensing unit, mounted on the first path; and
detecting the jam of the paper on the second path by a discharge sensing unit, mounted on the second path.

32. The jam removing method according to claim 31, wherein the selectively performing the pickup operation further comprises:
detecting the location of the paper, in response to the jam occurring in the image forming apparatus, by driving the driving source for the predetermined amount of time.

33. The jam removing method according to claim 32, further comprising:
controlling the pickup roller to operate, where the jammed paper is detected as being located only on the first path; and
controlling the pickup roller to not operate, where the at least a portion of the jammed paper is detected as being located on the second path.

34. A jam removing device of an image forming apparatus, comprising:
a jam detecting unit, mounted on a feed path and/or a discharge path of the image forming apparatus, to detect a jam of the paper in the image forming apparatus;
a drive controlling unit to drive a driving source of a discharging unit of the image forming apparatus for a predetermined amount of time, in response to the jam of the paper occurring in the image forming apparatus; and
a pickup determining unit to determine selectively performing a pickup operation by a pickup roller according to a detected location of the jammed paper relative to the feed and the discharge paths, in response to the driving of the driving source for the predetermined amount of time.

35. The jam removing device according to claim 34, wherein the drive controlling unit comprises:
an opening detecting unit to detect the opening of a cover unit of the image forming apparatus; and
a signal generating unit to generate a jam releasing signal and to drive the driving source for the predetermined amount of time, where the opening of the cover unit is detected by the opening detecting unit.

36. The jam removing device according to claim 35, wherein the jam detecting unit comprises:
a feed sensing unit, mounted on the feed path, to detect the jam of the paper on at least a portion of the feed path; and
a discharge sensing unit, mounted on the discharge path, to detect the jam of the paper on at least a portion of the discharge path.

37. The jam removing device according to claim 36, wherein the pickup determining unit comprises:
a pickup controlling unit to operate the pickup roller, where the jammed paper is located only on the feed path, and to not operate the pickup roller, where at least a portion of the jammed paper is located on the discharge path.

38. The jam removing device according to claim 37, wherein:
a conveying device, to convey the paper, is not mounted on the feed path.

39. The jam removing device according to claim 34, wherein:
a conveying device, to convey the paper, is not mounted on the feed path.

40. A jam removing device of an image forming apparatus, comprising:
a jam detecting unit to detect a jam of the paper on a feed path or a discharge path of the image forming apparatus; and
a pickup determining unit to determine selectively performing a pickup operation by a pickup roller according to a detected location of the jammed paper relative to the feed and the discharge paths.

41. The jam removing device according to claim 40, further comprising:
a discharging unit to discharge the jammed paper from the image forming apparatus along the discharge path.

42. A jam removing method of an image forming apparatus, comprising:
detecting a jam of the paper in a conveying path of the image forming apparatus, the conveying path comprising a first path and a second path;
selectively performing a pickup operation by a pickup roller of the image forming apparatus, according to a detected location of the jammed paper relative to the first and second paths.

43. The jam removing method according to claim 42, further comprising:
discharging the jammed paper from the image forming apparatus.
